(19) United States
(12) Patent Application Publication
(10) Pub. No.: US 2017/0066196 A1
(43) Pub. Date: Mar. 9, 2017

(54) SYSTEMS AND METHODS FOR WAVE FUNCTION BASED ADDITIVE MANUFACTURING

(71) Applicant: FEETZ, INC., Chattanooga, TN (US)

(72) Inventors: Nigel Beard, Chattanooga, TN (US); Walter Edmondson, Hixson, TN (US); John William Phillips, San Diego, CA (US); Francis Anthony Bitonti, East Moriches, NY (US); Lucy Beard, Chattanooga, TN (US)

(21) Appl. No.: 15/257,819

(22) Filed: Sep. 6, 2016

Related U.S. Application Data
(60) Provisional application No. 62/214,879, filed on Sep. 4, 2015.

(51) Int. Cl. B29C 67/00; B29D 35/02; B33Y 50/02; B33Y 10/00; B33Y 30/00

(52) U.S. Cl. CPC B29C 67/0088; B33Y 10/00; B33Y 30/00; B33Y 50/02; B29D 35/02; B29L 2031/50

(57) ABSTRACT

A system configured to facilitate formation of additive manufacturing objects is described. The system may obtain a virtual three-dimensional representation of an object, determine positions for a layered series of contour lines for the object based on the three-dimensional representation; and determine individual wave functions that correspond to a given contour line for a given layer. An individual wave function may indicate a three or more dimensional waveform pathway for an additive manufacturing platform to follow within a given layer when forming the given layer of the object. The system may control movement of the additive manufacturing platform to additively manufacture the object following waveform pathways. Controlling movement of the additive manufacturing platform based on the wave functions facilitates additively manufacturing objects without a need for support material for overhanging features. The present system is controlled to additively manufactured objects having a knit, weave, and/or other fabric-like texture.

### CROSS-REFERENCE TO RELATED APPLICATIONS

This application claims priority to pending U.S. Provisional Application No. 62/214,879 filed Sep. 4, 2015, which is incorporated herein by reference in its entirety.

### FIELD OF THE DISCLOSURE

This disclosure relates to systems and methods for facilitating formation of additive manufacturing objects by controlling movement of an additive manufacturing platform and processing of additive manufacturing material to additively manufacture the objects following waveform pathways.

### BACKGROUND

Additive manufacturing is known. One typical mode of additive manufacturing may involve layer-by-layer construction of a three-dimensional object by printing a consecutive series of two dimensional cross-sectional layers of the object with a build material. To execute this typical operational mode of additive manufacturing, an electronic three-dimensional mesh representative of a desired object may be used to generate a specific code (known as G-Code) which tells a printer where to move (in two dimensions within a layer and/or in a third dimension when moving from one layer to the next) and how much material to deposit at any given point. Where three-dimensional features of the printed object overhang during the additive manufacturing process, a temporary support material may typically be printed as part of the object, and later removed.

### SUMMARY

One aspect of the disclosure may relate to an additive manufacturing system configured to facilitate formation of additive manufacturing objects. The system may comprise an additive manufacturing platform, one or more hardware processors, and/or other components. The additive manufacturing platform may be configured to move in three or more dimensions to process additive manufacturing material to form an object. The one or more hardware processors may be configured by machine-readable instructions to obtain a virtual three-dimensional representation of the object. The virtual three-dimensional representation may convey one or more physical properties of the object. The one or more hardware processors may determine positions for a layered series of contour lines for the object based on the three-dimensional representation. The layered series of contour lines may correspond to cross-sectional shapes of the object in different two-dimensional layers of the object. The one or more hardware processors may determine individual wave functions based on the contour lines and the one or more physical properties of the object. An individual wave function may correspond to a given contour line for a given layer. An individual wave function may indicate a three or more dimensional waveform pathway for the additive manufacturing platform to follow within a given layer when printing the given layer of the object. The one or more hardware processors may control movement of the additive manufacturing platform and processing of the additive manufacturing material to additively manufacture the object following waveform pathways based on the wave functions determined for the different two-dimensional layers.

Another aspect of the disclosure may relate to an additive manufacturing method for facilitating formation of additive manufacturing objects. The method may comprise obtaining a virtual three-dimensional representation of an object. The virtual three-dimensional representation may convey one or more physical properties of the object. The method may comprise determining positions for a layered series of contour lines for the object based on the three-dimensional representation. The layered series of contour lines may correspond to cross-sectional shapes of the object in different two-dimensional layers of the object. The method may comprise determining individual wave functions based on the contour lines and the one or more physical properties of the object. An individual wave function may correspond to a given contour line for a given layer. An individual wave function may indicate a three or more dimensional waveform pathway for an additive manufacturing platform to follow within a given layer when printing the given layer of the object. The method may comprise controlling movement of the additive manufacturing platform and processing of additive manufacturing material to additively manufacture the object following waveform pathways based on the wave functions determined for the different two-dimensional layers.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an additive manufacturing system configured to facilitate formation of additive manufacturing objects, in accordance with one or more implementations.

FIG. 2 illustrates additive manufacturing of an object by an additive manufacturing platform, in accordance with one or more implementations.

FIG. 3 illustrates an additively manufactured shoe, in accordance with one or more implementations.

FIG. 4 illustrates first, second, third, and fourth examples of fabric-like structures additively manufactured by the system, in accordance with one or more implementations.

FIG. 5 illustrates a layered series of contour lines, in accordance with one or more implementations.

FIG. 6 illustrates a contour line and an illustration of a corresponding wave function for an additively manufactured layer of an object, in accordance with one or more implementations.

FIG. 7 illustrates examples of a sine function, a square function, a triangle function, and a saw tooth function, in accordance with one or more implementations.

FIG. 8 illustrates a sine function wherein the amplitude, wavelength, and period are specified, in accordance with one or more implementations.

FIG. 9 illustrates a portion of a shoe object having areas with different pore sizes, thicknesses, and/or differing waveforms in accordance with one or more implementations.

FIG. 10 illustrates a shoe object with an example smooth texture shape formed in an outer surface of the shoe object, in accordance with one or more implementations.

FIG. 11A illustrates a shoe object with an example smooth texture company logo formed in an outer surface of the shoe object, in accordance with one or more implementations.

FIG. 11B illustrates texturizing external waves to create smooth positive relief textures, in accordance with one or more implementations.

FIG. 11C illustrates texturizing external waves to create smooth negative relief textures, in accordance with one or more implementations.

FIG. 12 illustrates depictions of various soundwave functions, in accordance with one or more implementations.

FIG. 13 illustrates increased pixels for textures with waves only—positive relief textures, in accordance with one or more implementations.

FIG. 14 illustrates increased pixels for textures with waves only—negative relief textures, in accordance with one or more implementations.

FIG. 15 illustrates a Voroni pattern and a portion of a shoe object additively manufactured with the system based on wave functions determined for the Voroni pattern, in accordance with one or more implementations.

FIG. 16 illustrates several different examples of random and/or naturally occurring patterns from which the system may be configured to determine wave functions, in accordance with one or more implementations.

FIG. 17 illustrates controlling movement of an additive manufacturing platform to additively manufacture an object, in accordance with one or more implementations.

FIG. 18 illustrates a method for facilitating formation of additive manufacturing objects, in accordance with one or more implementations.

### DETAILED DESCRIPTION

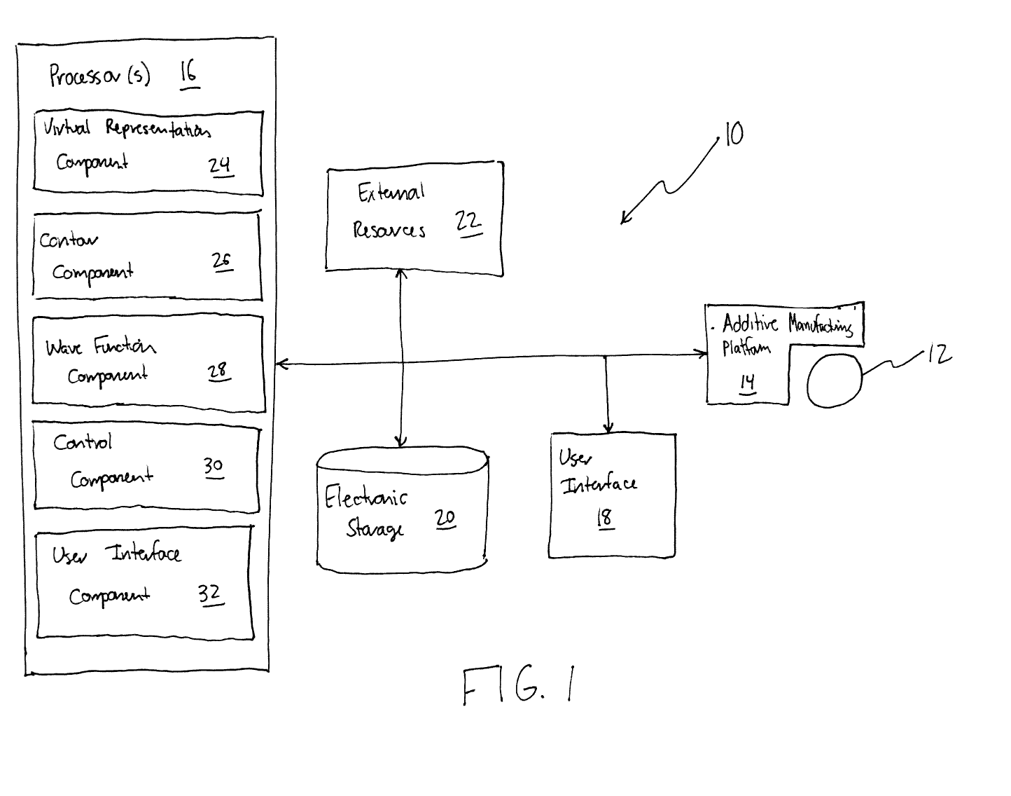

FIG. 1 illustrates an additive manufacturing system 10 configured to facilitate formation of additive manufacturing objects 12, in accordance with one or more implementations. In some implementations, additive manufacturing objects 12 may include shoes and/or other footwear, garments, textiles, accessories and/or other fashion articles, other outerwear and/or apparel, and/or other objects. System 10 may be configured to facilitate fabrication of objects 12 by controlling movement of an additive manufacturing platform 14 (e.g., a print head, a build plate, components and/or devices used in powder based additive manufacturing, components and/or devices used in resin based additive manufacturing, components and/or devices used in metal based additive manufacturing, components and/or devices used in stereolithography (SLA), components and/or devices used in selective laser sintering (SLS), and/or other devices used to form additive manufacturing object 12), processing of additive manufacturing material (e.g., extrusion rate, material temperature, material color, filament size, and/or other parameters), and/or other operations to additively (e.g., layer by layer) manufacture object 12 following waveform pathways. An individual waveform pathway may comprise a two, three, or more dimensional pathway that additive manufacturing platform 14 follows while forming an individual layer of an object 12. Waveform pathways may correspond to wave functions determined by system 10 and/or other information. An individual wave function may be and/or include one or more mathematical functions that describe the two, three, or more dimensional pathway for additive manufacturing platform 14 to follow while printing an individual layer of an object 12.

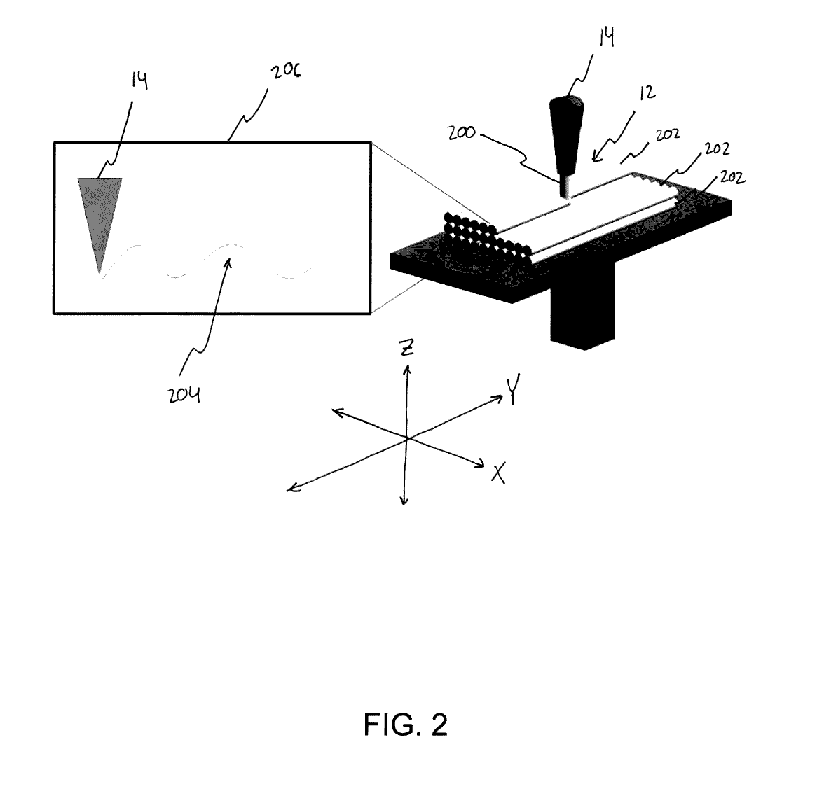

For example, FIG. 2 illustrates additive manufacturing of an object 12 by an additive manufacturing platform 14, in accordance with one or more implementations. Additive manufacturing platform 14 may be controlled to process additive manufacturing material 200 to additively (e.g., layer 202 by layer 202) manufacture object 12 following waveform pathways 204 illustrated in the (two-dimensional) enlarged view 206 of FIG. 2. As shown in view 206, additive manufacturing platform 14 may move in “X”, “Y”, “Z”, and/or other directions while printing an individual layer 202 of object 12.

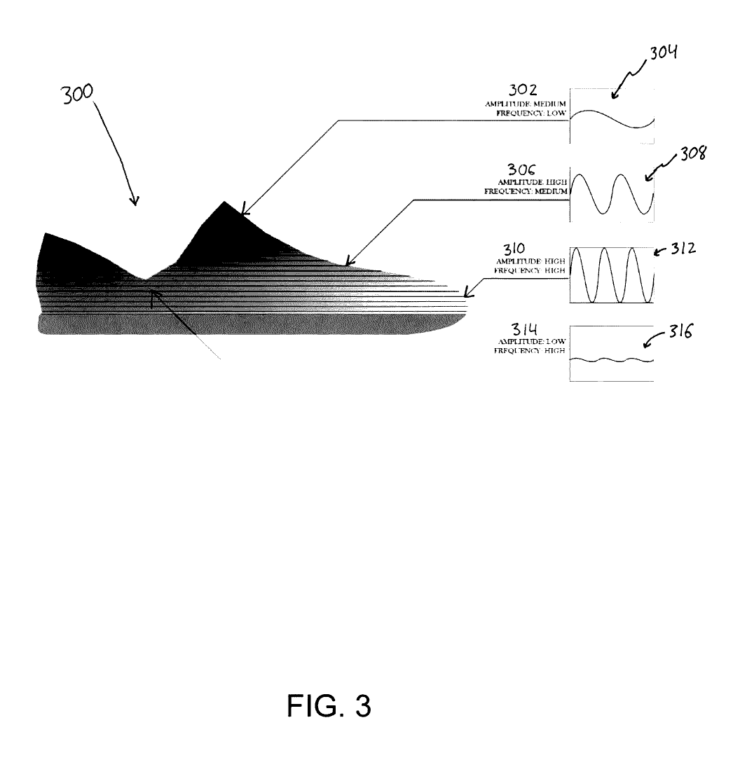

Advantageously, altering various parameters of the wave functions may facilitate customization of different physical properties of the objects 12 being manufactured. Changing wave function parameters such as wave function type, amplitude, wavelength, frequency, etc. may facilitate adjustment the physical properties in one or more individual areas of an object 12. For example, FIG. 3 illustrates an additively manufactured shoe 300, in accordance with one or more implementations. As shown in FIG. 3, a first portion 302 of shoe 300 may be manufactured using a relatively medium amplitude, low frequency waveform 304 (e.g., which may correspond to a wave function determined as described below). First portion 302 may be configured for elasticity, flexibility, breathability, and/or properties, for example. A second portion 306 of shoe 300 may be manufactured using a relatively high amplitude, medium frequency waveform 308. Second portion 306 may be configured for printability over large bridging areas such as a toebox and/or other properties, for example. A third portion 310 of shoe 300 may be manufactured using a relatively high amplitude, high frequency waveform 312. Third portion 310 may be configured for increased strength and/or protection for toes and/or other properties, for example. A fourth portion 314 of shoe 300 may be manufactured using a relative low amplitude, high frequency waveform 316. Fourth portion 314 may be configured for flexibility and/or a thinner fabric like texture and/or other properties, for example. (It should be noted that relative descriptions (e.g. high, medium, low, slow, fast, denser, more porous, etc.) herein may be described relative to other portions of a particular additive manufacturing object 12.)

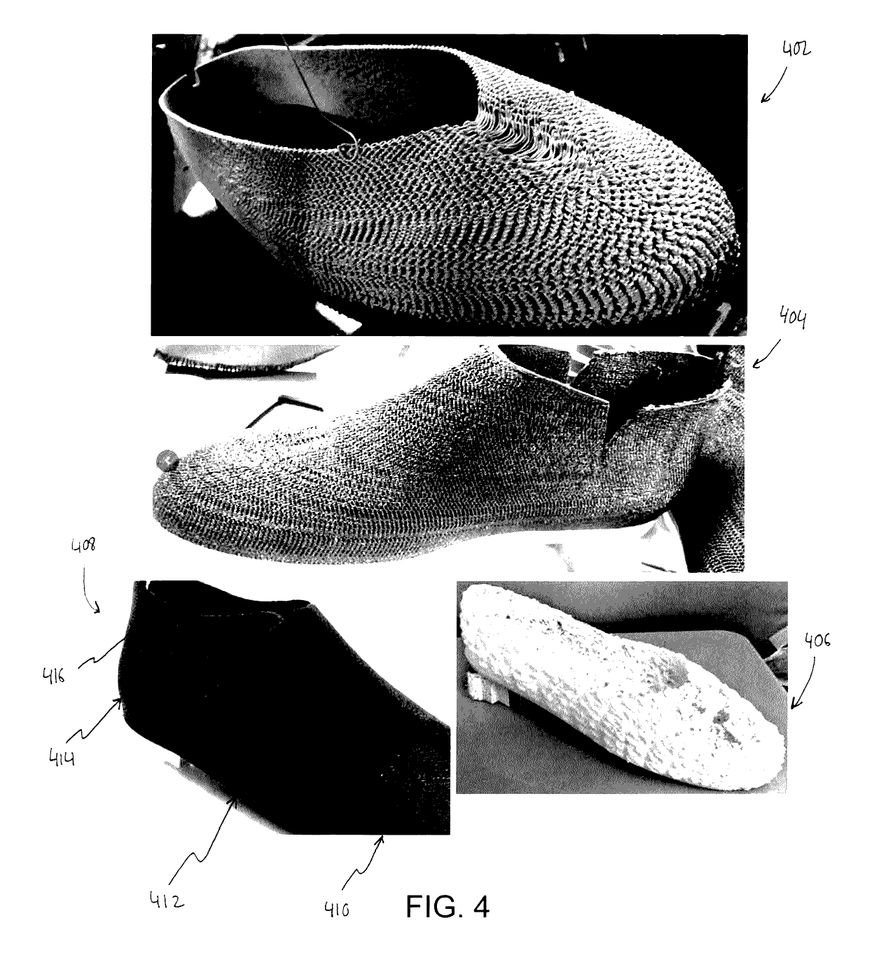

Further, the two, three, or more dimensional waveform pathway movement of additive manufacturing platform 14 (FIG. 1) while forming individual layers of objects 12 (FIG. 1) may facilitate fabrication of knit, fabric-like, soft textures, and/or other textures for objects 12; and/or fabrication of other structures. System 10 may be configured such that this texturing may provide visually aesthetic appearances customizable by users. Examples of fabric-like structures that may be additively manufactured by system 10 are shown in FIG. 4. FIG. 4 illustrates first 402, second 404, third 406, and fourth 408 examples (there are many more examples) of objects (e.g., objects 12 shown in FIG. 1) with fabric-like textures additively manufactured by system 10 (FIG. 1), in accordance with one or more implementations. First and second examples 402 and 404 illustrate two different versions of knit textures. Third example 406 illustrates an example of a lace texture additively manufactured by system 10 (FIG. 1). Fourth example 408 illustrates an example of an object having four separate textures 410, 412, 414, and 416 in four separate portions of the object.

In addition, the two, three, or more dimensional waveform pathway movement of additive manufacturing platform 14 (FIG. 1) while forming individual layers of objects 12 (FIG. 1) may facilitate fabrication of the knit, fabric-like, soft textures, and/or other textures for objects 12 without the need for support material for overhanging structures during manufacturing; and/or fabrication of other structures. The two, three, or more dimensional waveform pathway fabricated material may provide stability throughout additively manufactured angles and/or structures (e.g., overhanging portions, bridge sections, etc.) that may otherwise fail. System 10 (FIG. 1) may utilize wave-function based waveform print pathways to compensate for acute angles and/or large areas with bridging sections that would normally require support material during manufacturing of a printed object 12. The overlapping two, three, or more dimensional nature of a plurality of waveform pathway produced layers of object 12 may provide the necessary support for object 12 during a build so that separate support material is not required. These waveforms may be manipulated to provide increased surface area for the next layer to be deposited, effectively increasing the line width by adjusting the amplitude and frequencies of the waves.

Returning to FIG. 1, in some implementations, system 10 may comprise one or more of an additive manufacturing platform 14, a processor 16, a user interface 18, electronic storage 20, and/or other components. In some implementations, system 10 may be configured to communicate with and/or otherwise utilize external resources 22 as described herein. In some implementations, additive manufacturing platform 14, processor 16, user interface 18, electronic storage 20 and/or other components of system 10 may be located in a single additive manufacturing device. In some implementations, one or more of additive manufacturing platform 14, processor 16, user interface 18, electronic storage 20 and/or other components of system 10 may be located remotely from each other and configured to communicate via a network (e.g., the internet). The connection(s) to the network may be wireless or wired. For example, processor 16 may be located in a remote server and may wirelessly communicate with additive manufacturing platform 14 and/or other components of system 10 to form additive manufacturing objects 12 as described herein.

Additive manufacturing platform 14 may be configured to move in three-dimensions (or more) and process additive manufacturing material to form additive manufacturing objects 12. Platform 14 may be a stand-alone component and/or platform 14 may be included as a component (e.g., with processor 16, user interface 18, etc.) in additive manufacturing system 10. Platform 14 may be configured to process additive manufacturing material to form additive manufacturing objects 12 and/or perform other operations to form additive manufacturing objects 12. Platform 14 may include various motors, electronics, mechanical supports, and/or other components that facilitate movement during additive manufacturing operations. For example, platform 14 may include four and/or five axis robotic arms, and/or other components. Platform 14 may include components for performing additive manufacturing processes including one or more of material deposition, material solidification, masking, material removal, UV curing, oven curing, dipping, spraying, electronics assembly, CNC machining, and/or other components. Platform 14 may include one or more of a single nozzle deposition head, a multiple nozzle deposition head, a powder based chamber, a liquid/resin based chamber, a metal deposition head, and/or other components. In some implementations, platform 14 may be configured such that multiple materials may be deposited through a single head and/or multiple heads. In some implementations, additive manufacturing platform 14 and/or an additive manufacturing device associated with platform 14 may be configured to facilitate fused deposition modeling (FDM), selective laser sintering (SLS), stereolithography (SLA), continuous liquid interface production (CLIP), digital light processing, laser melting, extrusion, freeform fabrication, inkjet printing (e.g., wherein platform 14 may comprise multiple print heads), selective deposition lamination, electron beam melting, additive manufacturing in a subtractive mode, and/or other additive manufacturing operations. In some implementations, system 10 may include any type of additive manufacturing platform having one or more portions that move as an object 12 is fabricated.

Processor(s) 16 may be configured to provide information processing capabilities in system 10. As such, processor 16 may include one or more of a digital processor, an analog processor, a digital circuit designed to process information, an analog circuit designed to process information, a state machine, and/or other mechanisms for electronically processing information. Although processor 16 is shown in FIG. 1 as a single entity, this is for illustrative purposes only. In some implementations, processor 16 may include a plurality of processing units. These processing units may be physically located within the same device (e.g., within additive manufacturing platform 14), or processor 16 may represent processing functionality of a plurality of devices operating in coordination (e.g. a processor located in additive manufacturing platform 14, a processor that is part of a server associated with system 10, a processor that is part of a server associated with external resources 22, etc.).

As shown in FIG. 1, processor 16 may be configured via machine-readable instructions to execute one or more computer program components. The computer program components and/or machine-readable instructions may be configured to enable an expert, a user, and/or other users associated with system 10 to interface with processor 16, and/or other components of system 10, and/or provide other functionality attributed herein to processor 16. In some implementations, processor 16 may perform the operations described herein based on machine-readable instructions provided to processor 16 at manufacture of system 10, provided by a user via user interface 18, stored in electronic storage 20, and/or obtained by system 10 in other ways.

The one or more computer program components may comprise one or more of a virtual representation component 24, a contour component 26, a wave function component 28, a control component 30, a user interface component 32, and/or other components. Processor 16 may be configured to execute components 24, 26, 28, 30 and/or 32 by software; hardware; firmware; some combination of software, hardware, and/or firmware; and/or other mechanisms for configuring processing capabilities on processor 16.

As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 24, 26, 28, 30, and 32 are illustrated in FIG. 1 as being co-located within a single processing unit, in embodiments in which processor 16 comprises multiple processing units, one or more of components 24, 26, 28, 30, and/or 32 may be located remotely from the other components. The description of the functionality provided by the different components 24, 26, 28, 30, and/or 32 described below is for illustrative purposes, and is not intended to be limiting, as any of components 24, 26, 28, 30, and/or 32 may provide more or less functionality than is described. For example, one or more of components 24, 26, 28, 30, and/or 32 may be eliminated, and some or all of its functionality may be provided by other components 24, 26, 28, 30, and/or 32. As another example, processor 16 may be configured to execute one or more additional components that may perform some or all of the functionality attributed below to one of components 24, 26, 28, 30, and/or 32.

Virtual representation component 24 may be configured to obtain virtual three-dimensional representations of individual objects. The individual objects may include object 12 and/or other objects. The virtual three-dimensional representations may convey one or more physical properties of the objects 12 that may be additively manufactured. The virtual-three-dimensional representations may convey that one or more portions of an object 12 has physical properties different than, and/or the same as, one or more other portions of object 12. The physical properties of an object 12 may comprise material properties, physical dimensions, and/or other properties of object 12. In some implementations, the material properties, physical dimensions, and/or other properties may specify one or more shapes, densities, materials, thicknesses, textures, colors, surface finishes, strengths, compressibilities, rigidities, flexibilities, elasticities, durabilities, and/or other properties of object 12.

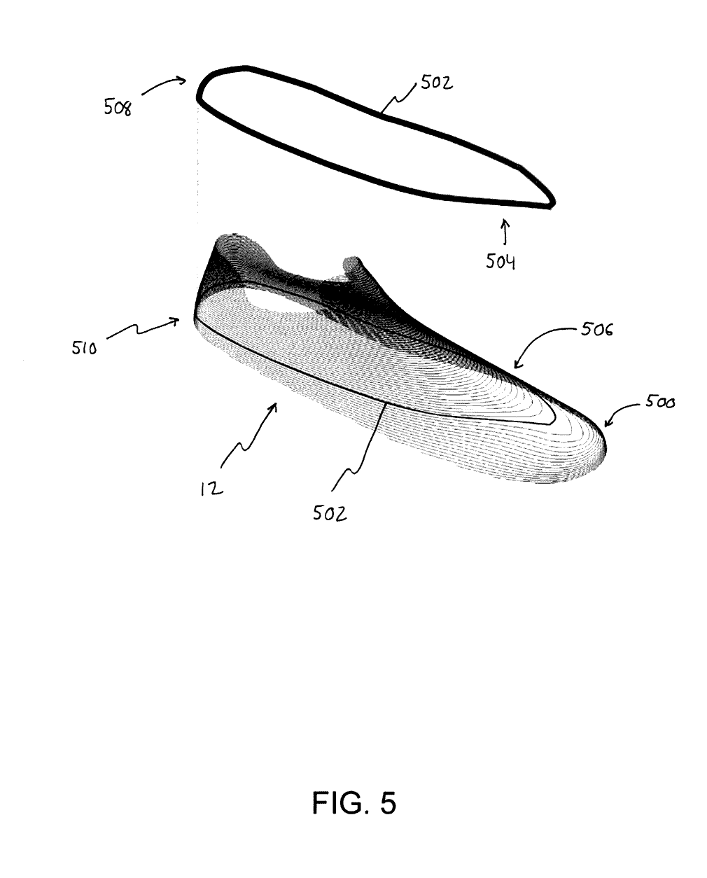

Contour component 26 may be configured to determine positions for a layered series of contour lines for a given object 12. Contour component 26 may determine the positions based on the virtual three-dimensional representation of an object 12 and/or other information. The layered series of contour lines may correspond to cross-sectional shapes of an object 12 in different two-dimensional layers of object 12. FIG. 5 illustrates a layered series 500 of contour lines 502, in accordance with one or more implementations. As shown in FIG. 5, individual contour lines 502 in layered series of contour lines 500 correspond to cross-sectional shapes of object 12 in different two-dimensional layers of object 12.

Returning to FIG. 1, wave function component 28 may be configured to determine individual wave functions based on the contour lines, the one or more physical properties of the object (e.g., object 12) being manufactured, and/or other information. Wave function component 28 may be configured such that individual layers of an object 12 and/or portions of layers may correspond to separate wave functions that may be determined (and/or manipulated) independently from wave functions for other layers and/or portions of layers. An individual wave function for a given layer may correspond to a given contour line for the given layer. An individual wave function may indicate a two, three, or more dimensional waveform pathway for additive manufacturing platform 14 to follow within a given layer when fabricating the given layer of object 12, a rate of deposition of material from additive manufacturing platform 14 (e.g., an extrusion rate), a rate of material solidification, a temperature of the material deposited by additive manufacturing platform 14, and/or other information. In some implementations, wave function component 28 may be and/or include custom Python code, for example, and/or other components. In some implementations, wave function component 28 may be configured such that the wave functions comprise programming code and/or other instructions for controlling additive manufacturing platform 14 and/or other components of system 10 as described herein.

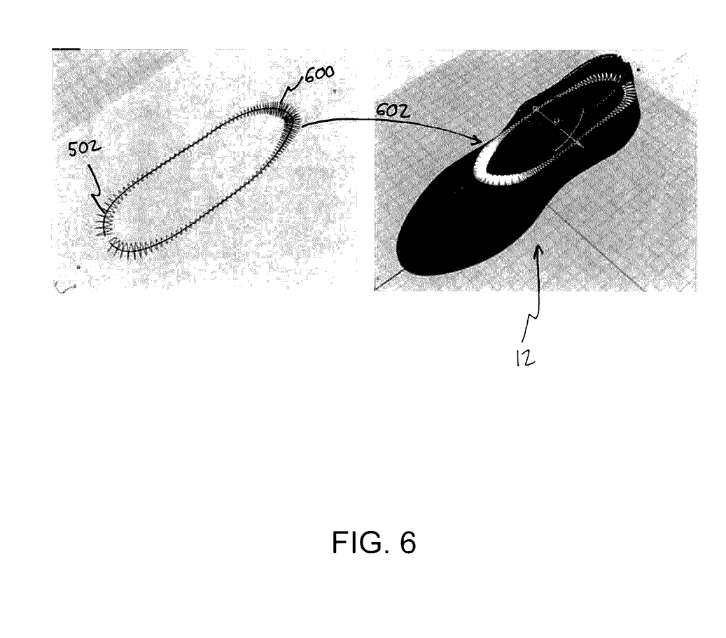

For example, FIG. 6 illustrates a contour line 502 and an illustration of a corresponding wave function 600 for an additively manufactured layer of an object 12, in accordance with one or more implementations. As shown in FIG. 6, wave function 600 is used, in combination 602 with other wave functions for other layers of object 12 to additively manufacture object 12.

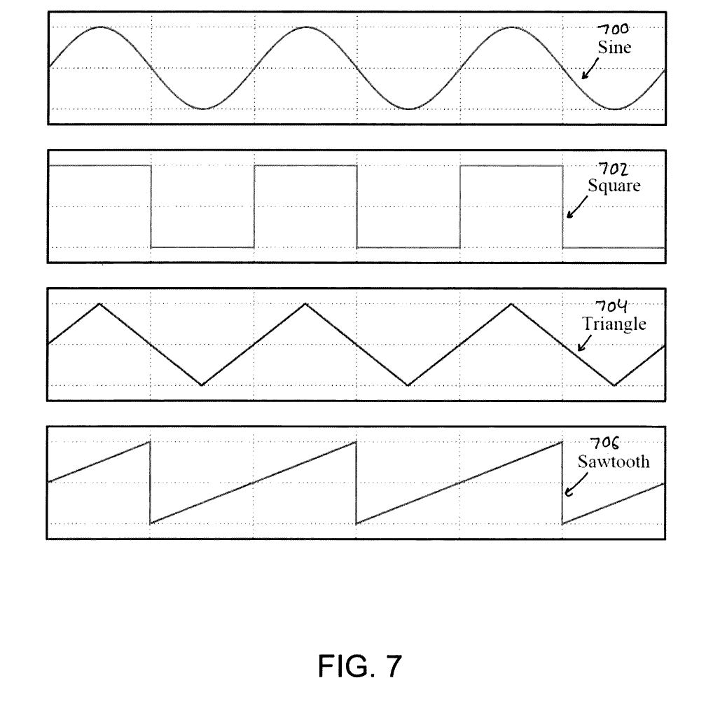

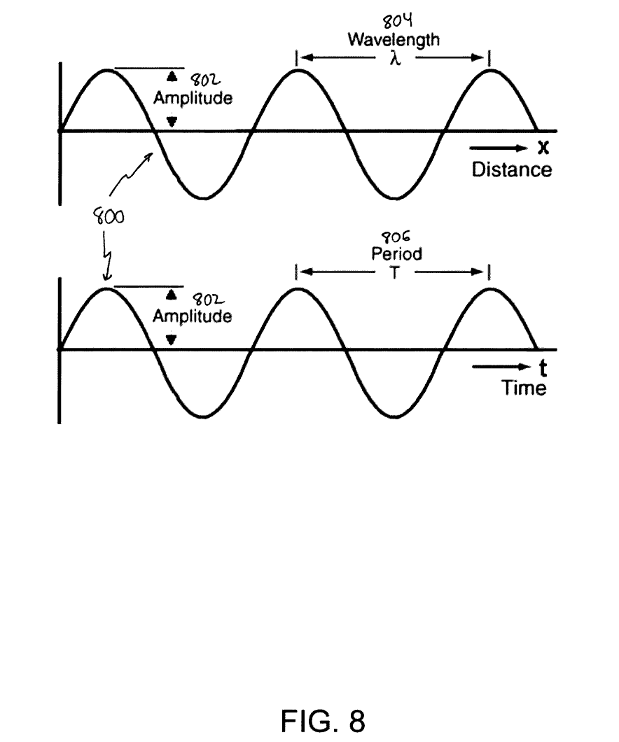

In some implementations, the wave function (e.g., wave function 600) comprises one or more of a sine function, a cosine function, a square function, a triangle function, a saw tooth function, a non-homogeneous function, a Monte-Carlo simulation based function, a Fast Fourier based function, a scalar function, an elastic function, a flocking function, wave harmonics, symmetric and anti-symmetric functions, a combination of such functions, and/or other functions. FIG. 7 illustrates examples (these are not intended to be limiting) of a sine function 700, a square function 702, a triangle function 704, and a saw tooth function 706, in accordance with one or more implementations. In some implementations, the individual wave functions may specify one or more amplitudes, wavelengths, frequencies, periods, and/or other characteristics of individual waveforms followed by additive manufacturing platform 14. For example, FIG. 8 illustrates a sine function 800 wherein the amplitude 802, wavelength 804, and period 806 are specified, in accordance with one or more implementations.

Returning to FIG. 1, wave function component 28 may be configured to determine and/or modulate the one or more amplitudes, wavelengths, frequencies, periods, and/or other characteristics of the individual wave functions such that the additively manufactured objects 12 have the one or more physical properties conveyed by the three-dimensional virtual representations. In some implementations, wave function component 28 may determine the one or more amplitudes, wavelengths, frequencies, and/or periods of the individual wave functions such that an additively manufactured object 12 has individual portions that are stronger, more flexible, softer, stiffer, smoother, rougher, mores dense, less dense, etc. than other areas of object 12. In some implementations, wave function component 28 may determine the one or more amplitudes, wavelengths, frequencies, and/or periods of the individual wave functions such that an additively manufactured object 12 has individual portions with different surface finishes. For example, in some implementations, wave function component 28 may determine the one or more amplitudes, wavelengths, frequencies, and/or periods of the individual wave functions such that one or more portions of an additively manufactured object 12 has a knit, weave, fabric-like, and/or other texture (e.g., as described above); such that an object 12 has one or more portions with a smooth and/or other surface finish corresponding to the shape of a company logo and/or other shapes; and/or other textures.

In some implementations, wave function component 28 may be configured to obtain wave function information (e.g., via user interface 18) and determine the individual wave functions based on the three-dimensional virtual representation, the wave function information, and/or other information. The wave function information may include one or more of locations of frequency and/or amplitude attractors and/or repellors in the three-dimensional representation, an attractor/repellor strength, a specification of which portions of which contour lines wave functions (and/or wave functions with specific characteristics) should be applied to, a base wave function amplitude, a base wave function frequency, wave function frequency and/or amplitude thresholds, a filament thickness, a desired print resolution, and/or other information.

In some implementations, attractors may comprise a point in three dimensional space in which it's effectiveness over a base wave is defined by proximity to this point (For example, as a waveform gets closer to an attractor wave function properties are increased by a multiplying ratio set by the attractor. Conversely, as a waveform gets closer in proximity to a repellor, the waveform function properties are decreased by a dividing ratio set by the repellor. The function of the attractor/repellor is not limited to multiply or dividing but can be any mathematically derived function.) In some implementations, attractors and/or repellors may be previously placed at one or more locations in a virtual representation of an object 12. In some implementations, wave function component 28 may be configured such that attractors and/or repellors may be placed and/or manipulated by a user via user interface 18 and/or other components, for example.

In some implementations, wave function component 28 may facilitate the ability to interact with the global waveforms using attractors and/or repellors that themselves may be derived from mathematical functions and/or from user input both real-time and/or preprint.

An example of specifying which portions of which contour lines wave functions, and/or wave functions with specific characteristics, should be applied to is illustrated in FIG. 5. As described above, FIG. 5 illustrates a layered series 500 of contour lines 502, in accordance with one or more implementations. Wave function component 28 (FIG. 1) may be configured such that a wave function (and/or portion of a wave function) determined for a first portion 504 of contour line 502 indicates that material should be deposited in an area 506 of object 12 with a relatively low frequency, high amplitude wave function at a fast material feed rate and a high temperature. This may provide more flexibility in area 506 of object 12, for example. Wave function component 28 may be configured such that a wave function (and/or portion of a wave function) determined for a second portion 508 of contour line 502 indicates that material should be deposited in an area 510 of object 12 with a relatively high frequency wave function at a slow material feed rate and a low temperature. This may provide a denser structure having increased structural rigidity in area 510 of object 12, for example.

Iteratively repeating such wave function determinations (e.g., making slight manipulations to the wave function based on the virtual representation, the wave function information, and/or other information) layer by layer for a given object 12 such as a shoe (the example shown in FIG. 5) may provide areas of increased support and/or flexibility, areas of increased breathability (e.g., to facilitate heat management), and/or areas with other characteristics, based on the needs and/or the biomechanics (e.g. foot bend, heel/arch support) of a person wearing the shoe and/or based on other information.

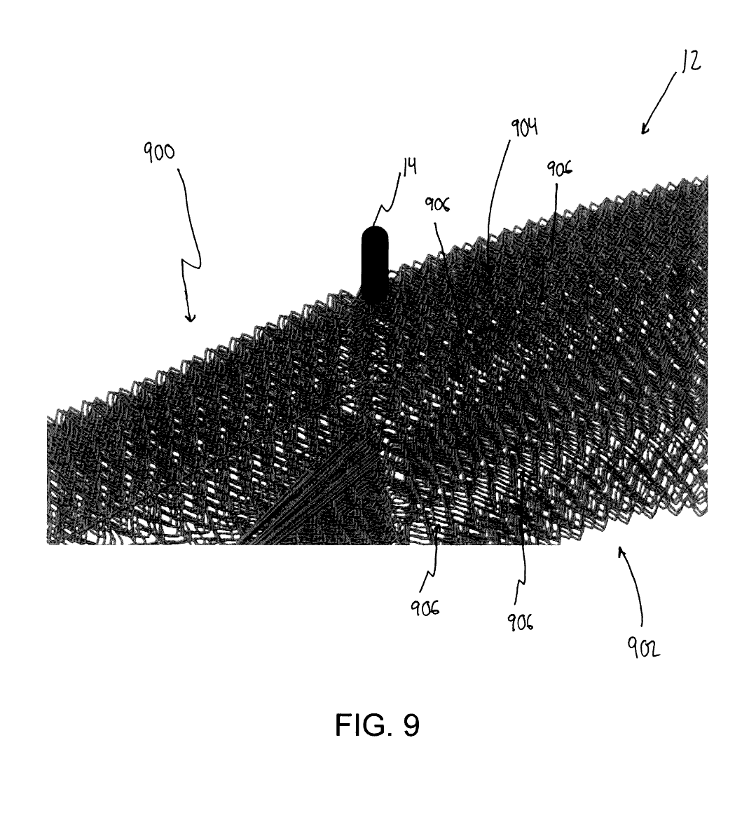

Providing areas of increased breathability for a shoe object 12 is illustrated in FIG. 9. FIG. 9 illustrates a portion 900 of a shoe object 12 having areas 902 and 904 with different pore 906 sizes, in accordance with one or more implementations. As described above, wave function component 28 (FIG. 1) may determine wave functions and/or portions of wave functions that correspond to contour lines and/or portions of contour lines for individual layers of shoe object 12 such that (after fabrication by additive manufacturing platform 14) areas 902 have more and/or larger pores 906 relative to areas 904. This may facilitate increased breathability in areas 902 relative to areas 904 of shoe object 12, for example.

As described above, wave function component 28 (FIG. 1) may determine the one or more amplitudes, wavelengths, frequencies, periods, and/or other characteristics of the individual wave functions and/or portions of wave functions such that an object 12 has one or more portions with a smooth texture and/or other surface finish corresponding to the shape of a company logo and/or other shapes, and/or other textures. In some implementations, such textures for a shoe object 12 may include style lines, heel cups, toe caps, etc. for example.

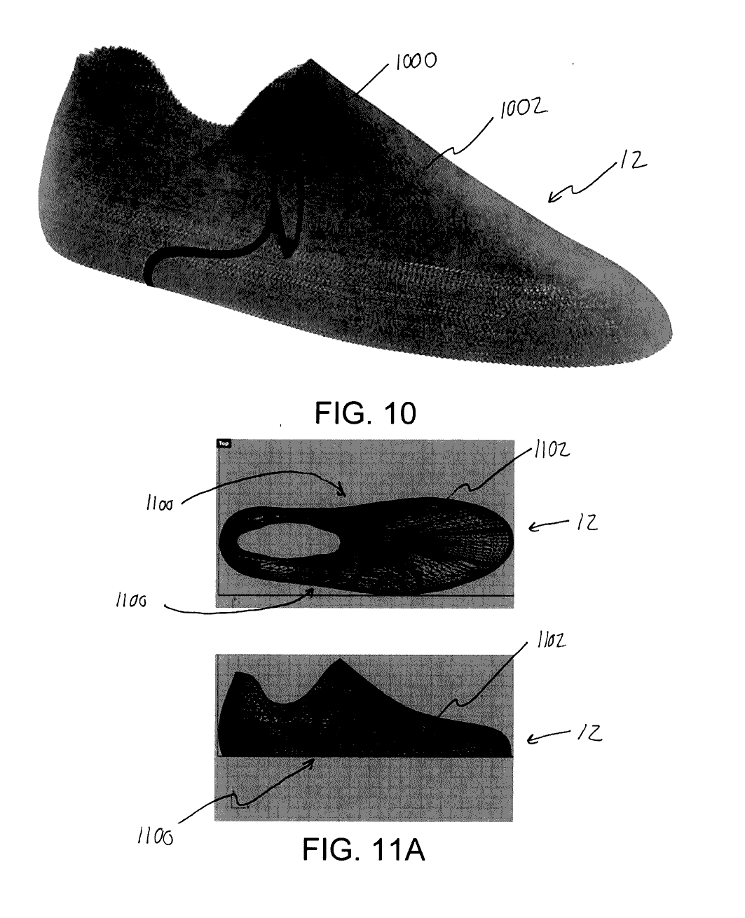

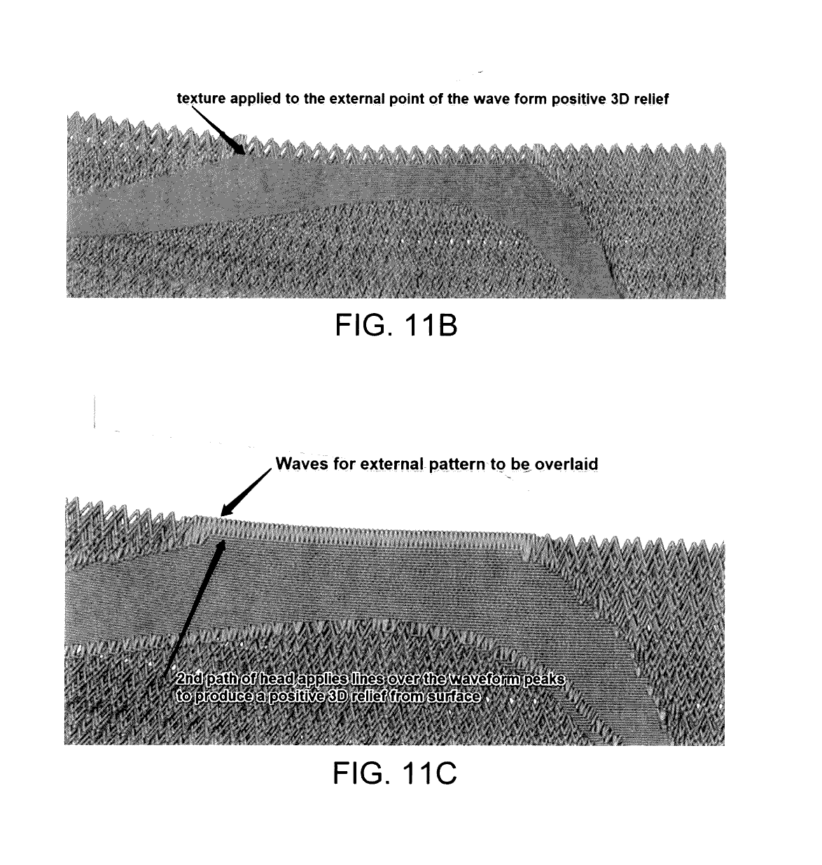

FIG. 10 illustrates a shoe object 12 with an example smooth texture (e.g., relative to other portions of shoe object 12) shape 1000 formed in an outer surface 1002 of shoe object 12, in accordance with one or more implementations. FIG. 11A illustrates a shoe object 12 with an example smooth texture company logo 1100 formed in an outer surface 1102 of shoe object 12, in accordance with one or more implementations. Such surface finishes may be formed based on wave functions and/or portions of wave functions (e.g., that correspond to an outer surface of an object 12) whose amplitudes, wavelengths, frequencies, periods, and/or other characteristics have been manipulated by wave function component 28 to produce a smoothed area of a surface of object 12 having the desired shape. For example, smooth surfaces can be applied to the external (or internal) point of the waveforms using a secondary operation of the additive manufacturing platform by reversing over the area and depositing another layer of materials over the top of the waves points. FIG. 11B and FIG. 11C show how this can be accomplished in both positive and negative relief planes to the waveforms generating smooth textures above and below the external surfaces.

Returning to FIG. 1, in some implementations, wave function component 28 may be configured such that the wave functions may comprise soundwave functions and/or other functions. The soundwave functions may be generated (e.g., via external resources 22) based on music, voices, animal sounds, sounds from a city, and/or other sounds.

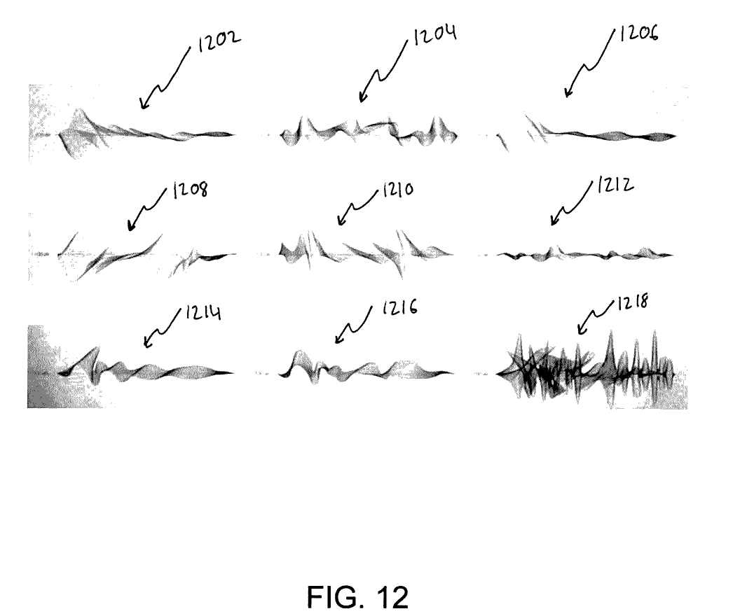

By way of several non-limiting examples, FIG. 12 illustrates depictions of various soundwave functions, in accordance with one or more implementations. FIG. 12 illustrates depictions 1202, 1204, 1206, of soundwave functions which may be representative of recorded animal sounds and/or other sounds; depictions 1208, 1210, 1212, of soundwave functions which may be representative of vehicle sounds and/or other noises recorded in a city; depictions 1214, 1216 of soundwave functions which may be representative of recorded music and/or other sounds; and a depiction 1218 of a soundwave function which may be representative of children's voices and/or other sounds. In this example (there are many more possible recordable sounds), wave functions may be determined based on any and/or all of these soundwaves such that the soundwaves may be integrated into an additively manufactured object 12 (e.g., a shoe) as described herein. Such soundwave functions may be used to determine one or more portions of wave functions for one or more layers of an additive manufacturing object 12 (FIG. 1).

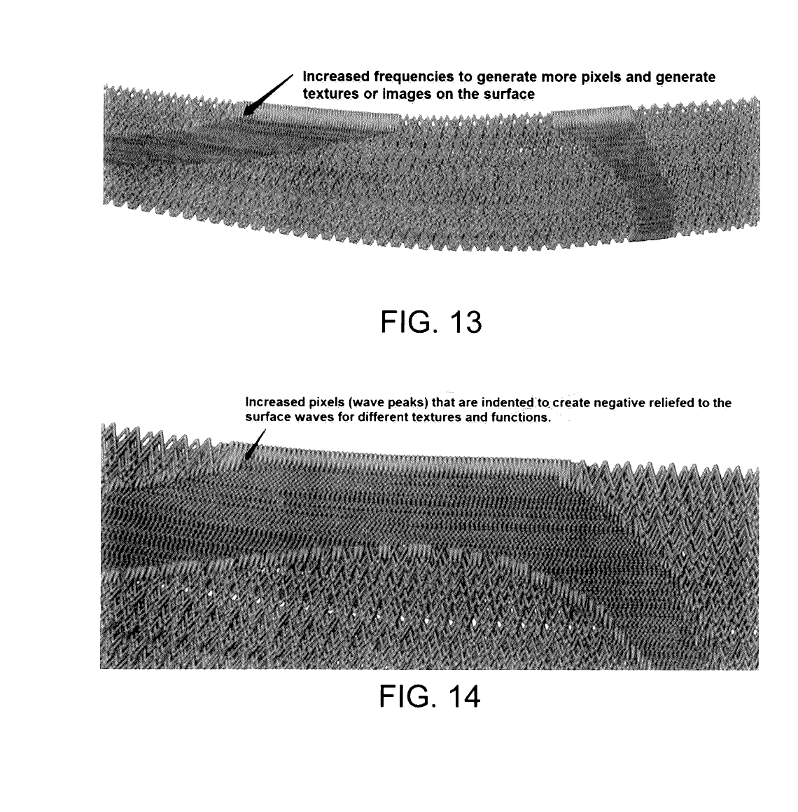

Returning to FIG. 1, in some implementations, wave function component 28 may be configured to determine wave functions based on digital and/or digitized images. Wave function component 28 may be configured to determine wave functions (and/or portions thereof for a given layer) based on an analysis of pixels in an image and/or other image information. The analysis may comprise, for example, a grey scale image wherein (e.g., 256) each point in the grey scale can be assigned a height. That height is then represented through the amplitude of the wavelength and the spacing between pixels is represented by the period or wavelength of the wave, thereby creating a three-dimensional texture from a three-dimensional image or photo (for example). This is not limited to grey scale and can be done in color and/or any other digitized format of an image. FIG. 13 and FIG. 14 show how the image can be represented through pixels that are either positive or negative relief to the waveform surface generating a three dimensional representation on an image. FIG. 13 illustrates increased pixels for textures with waves only—positive relief textures, in accordance with one or more implementations. FIG. 14 illustrates increased pixels for textures with waves only—negative relief textures, in accordance with one or more implementations. These effects are not limited to just images but also provide the ability to create additional biomechanical functionality and/or material properties such as, but not limited to, flexibility, bendability, increased strength, breathability, porosity, and style lines.

In some implementations, wave function component 28 may be configured to determine wave functions based on naturally occurring patterns, random patterns, and/or other patterns. In some implementations, wave function component 28 may be configured to facilitate programming (e.g., via user interface 18), uploading (e.g., via user interface 18), and/or other determining of wave functions that describe naturally occurring patterns, random patterns, and/or other patterns. In some implementations, wave function component 28 may be configured to determine wave functions for naturally occurring patterns, random patterns, and/or other patterns based on digital and/or digitized images of such patterns (e.g., using the pixel analysis described above).

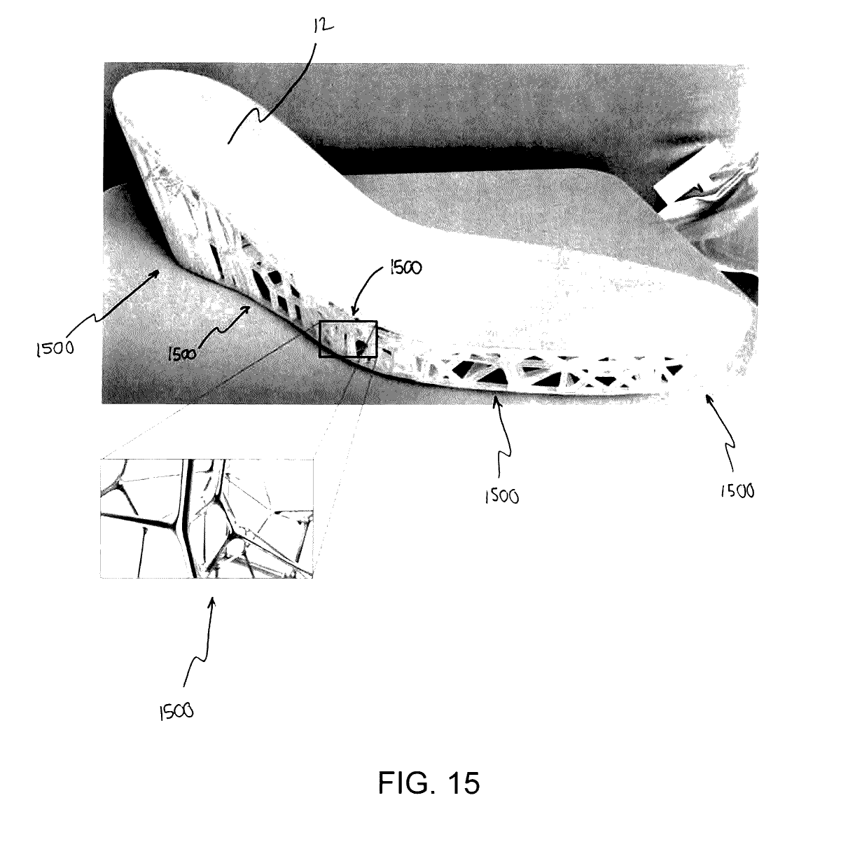

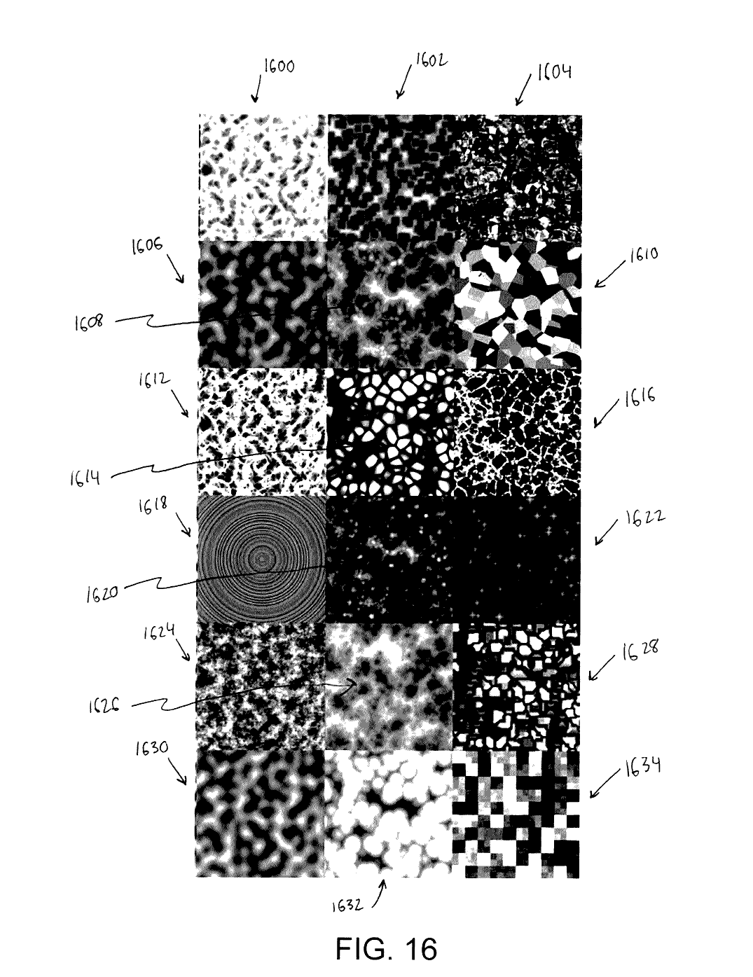

For example, FIG. 15 illustrates a Voronoi pattern 1500 and a portion of a shoe object 12 additively manufactured with system 10 (FIG. 1) based on wave functions determined for the Voronoi pattern, in accordance with one or more implementations. FIG. 16 illustrates several different examples 1600-1634 of random and/or naturally occurring patterns from which wave function component 28 (FIG. 1) may be configured to determine wave functions, in accordance with one or more implementations.

Returning to FIG. 1, control component 30 may be configured to control movement (e.g., position, direction, speed, etc.) of additive manufacturing platform 14, processing of additive manufacturing material (e.g., quantity, rate, temperature, color, etc.), and/or other operations to additively manufacture an object 12 following waveform pathways. The control may be based on the wave functions determined for the different two-dimensional layers and/or other information. In some implementations, controlling additive manufacturing platform 14 may include causing additive manufacturing platform 14 to move and/or process material according to a first waveform pathway that corresponds to a first wave function (e.g., determined as described above) for a first layer of an object 12, causing additive manufacturing platform 14 to move and/or process material according to a second waveform pathway that corresponds to a second wave function (e.g., determined as described above) for a second layer of an object 12, and so on. As describe above, a wave function (and also a waveform) may vary within an individual layer.

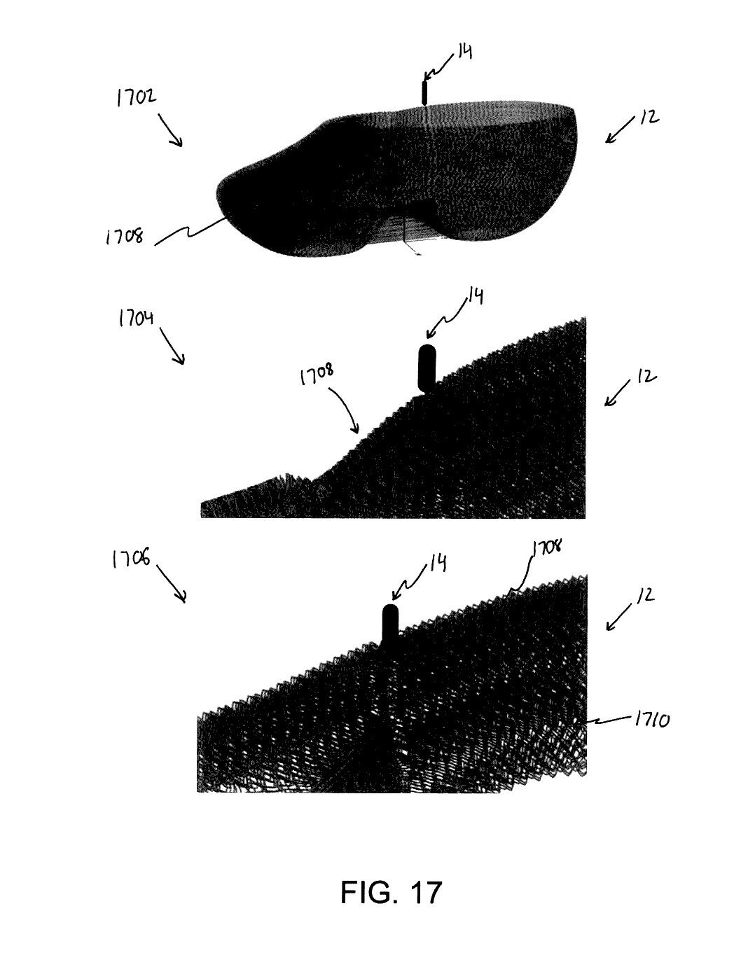

By way of a non-limiting example, FIG. 17 illustrates controlling movement of additive manufacturing platform 14 to additively manufacture an object 12, in accordance with one or more implementations. As shown in the views 1702, 1704, and 1706 of object 12 in FIG. 17, additive manufacturing platform 14 may be controlled to facilitate layer by layer manufacturing of object 12. Views 1704 and 1706 may be enlarged views of portions of object 12 during the additive manufacturing process. As described herein and shown in FIG. 17, layer by layer waveform pathway printing may facilitate fabrication of knit, fabric-like, soft textures 1708. In addition, the overlapping, three or more dimensional nature 1710 of individual printed layers may reduce and/or eliminate the need for support material during the build.

Returning to FIG. 1, user interface component 32 may cause user interface 18 to provide information to and/or receive information from users. This may include causing user interface 18 to display a graphical user interface to users. The graphical user interface may be configured to present views and/or fields of the graphical user interface that provide information to users, and/or receive entry and/or selection of information from users. The views and/or fields may present and/or receive information related to the virtual three-dimensional representations of additive manufacturing objects 12, properties of objects 12, wave function information, information related to the additive manufacturing device, and/or other information. By way of several non-limiting examples, user interface component 32 may cause presentation of modeling software views and/or fields, and/or views and/or fields for adjusting virtual three-dimensional representations of objects 12 created using separate modeling software (e.g., adjustment of attractors). User interface component 32 may cause user interface 18 to present one or more views of the graphical user interface that include one or more fields configured to facilitate entry of the wave function information. User interface component 32 may cause presentation of one or more fields and/or views depicting wave functions used to generate an object 12. These examples are not intended to be limiting.

User interface 18 may be configured to provide an interface between system 10 and a user through which the user may provide information to and receive information from system 10. This enables data, cues, results, and/or instructions and any other communicable items, collectively referred to as “information,” to be communicated between the user and system 10. Examples of interface devices suitable for inclusion in user interface 18 comprise a touch screen, a keypad, buttons, switches, a keyboard, knobs, levers, a display screen, speakers, a microphone, an indicator light, an audible alarm, a printer, a computer mouse, and/or other interface devices. In some implementations, user interface 18 comprises a plurality of separate interfaces (e.g., a display screen, a mouse, and a keyboard). In some implementations, user interface 18 comprises one interface (e.g., a touchscreen, a keypad, etc.) that is provided integrally with processor 16.

User interface 18 may be and/or include a graphical user interface configured to present views and/or fields of the graphical user interface that provide information to users, and/or receive entry and/or selection of information from users. As described above, the views and/or fields may present and/or receive information related to the virtual three-dimensional representations of additive manufacturing objects 12, properties of objects 12, wave function information, information related to the additive manufacturing device, and/or other information.

It is to be understood that other communication techniques, either hard-wired or wireless, are also contemplated by the present disclosure as user interface 18. For example, the present disclosure contemplates that user interface 18 may be integrated with a removable storage interface provided by electronic storage 20. In this example, information may be loaded into system 10 from removable storage (e.g., a smart card, a flash drive, a removable disk, etc.) that enables the user to customize the implementation of system 10. Other exemplary input devices and techniques adapted for use as user interface 18 comprise, but are not limited to, an RS-232 port, RF link, an IR link, modem (telephone, cable or other). In short, any technique for communicating information with system 10 is contemplated by the present disclosure as user interface 18.

Electronic storage 20 may comprise electronic storage media that electronically stores information in system 10. Electronic storage 20 may be configured to store software algorithms, information determined by processor 16, information received via user interface 18, and/or other information that enables system 10 to function as described herein. The electronic storage media of electronic storage 20 may comprise one or both of system storage that is provided integrally (i.e., substantially non-removable) with one or more components of system 10 and/or removable storage that is removably connectable to one or more components of system 10 via, for example, a port (e.g., a USB port, a firewire port, etc.) or a drive (e.g., a disk drive, etc.). Electronic storage 20 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 20 may be (in whole or in part) a separate component within one or more components of system 10, or electronic storage 20 may be provided (in whole or in part) integrally with one or more other components of system 10 (e.g., additive manufacturing platform 14, processor 16, user interface 18, etc.).

External resources 22 may include sources of information (e.g., databases, websites, etc.), external entities participating with system 10 (e.g., a computing device that stores virtual representations of various additive manufacturing objects 12, a 3D modeling software system, etc.), one or more servers outside of system 10, a network (e.g., the internet), electronic storage, equipment related to Wi-Fi technology, equipment related to Bluetooth® technology, data entry devices, electronic communication devices (e.g., devices configured to communicate the virtual representations of objects 12 to system 10) and/or other resources. In some implementations, some or all of the functionality attributed herein to external resources 22 may be provided by resources included in system 10. External resources 22 may be configured to communicate with processor 16, additive manufacturing platform 14, user interface 18, electronic storage 20, and/or other components of system 10 via wired and/or wireless connections, via a network (e.g., a local area network and/or the internet), via cellular technology, via Wi-Fi technology, and/or via other resources.

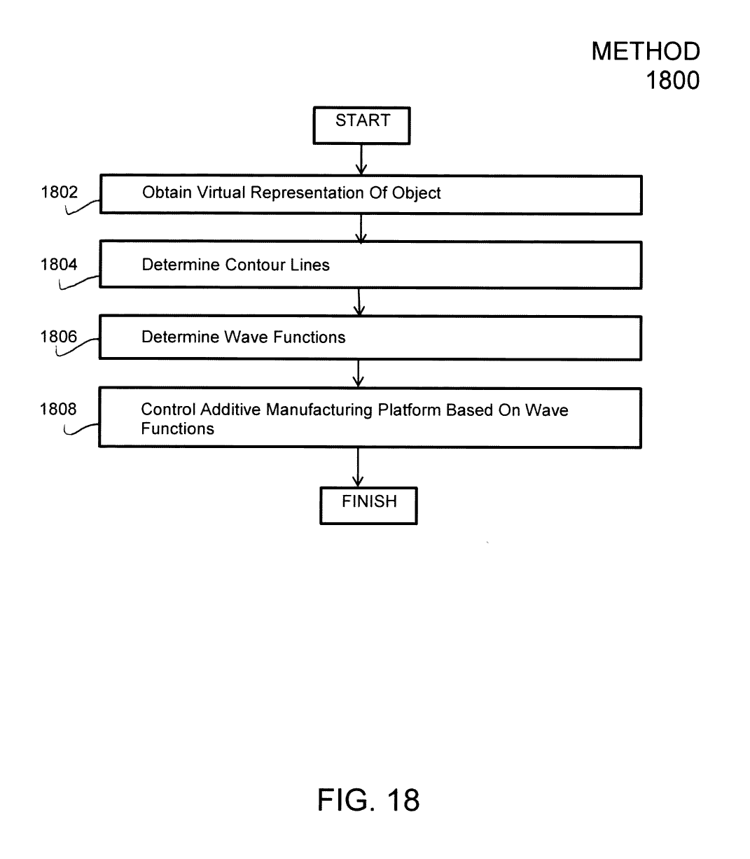

FIG. 18 illustrates a method 1800 for facilitating formation of additive manufacturing objects, in accordance with one or more implementations. The additive manufacturing objects may include shoes and/or other objects. The operations of method 1800 presented below are intended to be illustrative. In some implementations, method 1800 may be accomplished with one or more additional operations not described, and/or without one or more of the operations discussed. Additionally, the order in which the operations of method 1800 are illustrated in FIG. 18 and described below is not intended to be limiting.

In some implementations, one or more operations of method 1800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1800 in response to instructions stored electronically on an electronic storage medium. The one or more processing devices may include one or more devices configured through hardware, firmware, and/or software to be specifically designed for execution of one or more of the operations of method 1800.

At an operation 1802, a virtual three-dimensional representation of an object may be obtained. The virtual three-dimensional representation may convey one or more physical properties of the object, and/or other information. The physical properties of the object may comprise material properties and physical dimensions of the object, and/or other information. The material properties and physical dimensions may specifying one or more shapes, densities, materials, thicknesses, textures, colors, and/or other characteristics of the object. Operation 1802 may be performed by a processor component that is the same as or similar to virtual representation component 24 (as described in connection with FIG. 1), in accordance with one or more implementations.

At an operation 1804, contour lines may be determined. In some implementations, operation 1804 may include determining positions for a layered series of contour lines for the object based on the three-dimensional representation and/or other information. The layered series of contour lines may correspond to cross-sectional shapes of the object in different two-dimensional layers of the object. Operation 1804 may be performed by a processor component that is the same as or similar to contour component 26 (as described in connection with FIG. 1), in accordance with one or more implementations.

At an operation 1806, wave functions may be determined. The individual wave functions may specify one or more amplitudes, wavelengths, frequencies, periods, and/or other characteristics of individual waveforms followed by the additive manufacturing platform. In some implementations, operation 1806 may include determining individual wave functions based on the contour lines, the one or more physical properties of the object, and/or other information. An individual wave function may correspond to a given contour line for a given layer. An individual wave function may indicate a three or more dimensional waveform pathway for an additive manufacturing platform to follow within a given layer when printing the given layer of the object. A wave function may comprise one or more of a sine function, a cosine function, a square function, a triangle function, a saw tooth function, and/or other functions and/or combinations of functions. In some implementations, operation 1806 may include obtaining wave function information and determining the individual wave functions based on the wave function information. The wave function information may include one or more of locations of frequency and/or amplitude attractors in the virtual three-dimensional representation, a specification of which portions of which contour lines wave functions should be applied to, a base wave function amplitude, a base wave function frequency, an attractor strength, wave function frequency and/or amplitude thresholds, a filament thickness, a desired print resolution, and/or other wave function information. In some implementations, operation 1806 may include determining the one or more amplitudes, wavelengths, frequencies, periods, and/or other characteristics of the individual wave functions such that the additively manufactured object has the one or more physical properties of the object conveyed by the virtual three-dimensional representation. In some implementations, operation 1806 may include determining the one or more amplitudes, wavelengths, frequencies, periods, and/or other characteristics of the individual wave functions such that the additively manufactured object has a knit, weave, and/or fabric-like texture. In some implementations, the wave function may comprise a soundwave function. The soundwave function may be generated based on music, a voice, animal sounds, sounds from a city, and/or other noise. Operation 1806 may be performed by a processor component that is the same as or similar to wave function component 28 (as described in connection with FIG. 1), in accordance with one or more implementations.

At an operation 1808, an additive manufacturing platform may be controlled based on the wave functions. In some implementations, operation 1808 may include controlling movement of the additive manufacturing platform and processing of additive manufacturing material to additively manufacture the object following waveform pathways based on the wave functions determined for the different two-dimensional layers. In some implementations, operation 1808 may include controlling movement of the additive manufacturing platform based on the wave functions to additively manufacture the object without a need for support material for overhanging features. Operation 1808 may be performed by processor component that is the same as or similar to control component 30 (as described in connection with FIG. 1), in accordance with one or more implementations.

Returning to FIG. 1, the following non-limiting examples (there are many others) may illustrate one or more portions of the additive manufacture of a shoe by system 10. As a first example, a shell of a shoe (e.g., a virtual three-dimensional representation) may be designed in a 3D modeling software program (e.g., that may be part of external resources 22). (This shell may be obtained by virtual representation component 24 for example). This shell may represent a mean surface of the final printed shoe, between an inner and outer shell of the design. Contour lines may be generated (e.g., by contour component 26) by intersecting a plane with the model at individual “Z” heights at fixed distances from a specific surface (e.g., the bottom) of the model (shell). The line spacing (e.g., the “Z” heights) may be chosen based on the printer (e.g., additive manufacturing platform 14) for which a g-code is destined.

Wave function component 28 may facilitate placement (e.g., via user interface 18) of “attractors” or “repellors” at various locations in the model and determine the wave functions for the individual layers based on the model including the “attractors” and/or other information. Attractors may affect the amplitude, frequency, and/or other properties of the waves during wave function determination. Wave function component 28 may be configured such that custom Python code is imported into the 3D modeling software and executed. The code may facilitate the gathering of wave function information and/or other information from a user. Wave function component 28 may obtain wave function information and determine the individual wave functions based on the wave function information. The wave function information may include one or more of locations of frequency and/or amplitude attractors in the three-dimensional representation (model), a specification of which portions of which contour lines wave functions should be applied to, a base wave function amplitude, a base wave function frequency, an attractor strength, wave function frequency and/or amplitude thresholds, a filament thickness, a desired print resolution, and/or other information. Based on the desired properties of the additive manufacturing object 12, the contour lines, the wave function information, the Python code, and/or other information, wave function component 28 may apply a wave function to the curves (e.g., overlaying one or more waveforms over the two-dimensional representations of the individual layers) that make up the shoe. Wave function component 28, via the Python code and/or other information, then generates a g-code used by control component 30 to control additive manufacturing platform 14 to additively manufacture an object 12. System 10 may be configured such that an external slicing program is unnecessary.

As a second example, system 10 may be configured such that a designer and/or other users may sketch the basic shell of a loafer, for example, in the 3D modeling software. A majority of the shoe may be fabricated with a base wave function frequency and/or amplitude. However, the designer may desire a thinner heel cup and a thicker vamp for strength and/or better print quality purposes, so system 10 (e.g., wave function component 28) may facilitate (e.g., via user interface 18) placement of attractor points near the heel and/or vamp accordingly.

As a third example, system 10 may be configured such that a designer and/or other users may sketch the basic shell of the same loafer in the 3D modeling software. Along with 3D scans of both of their feet (e.g., obtained by virtual representation component 24 via a scanner that is part of external resources 22 and used by contour component 26 to generate the contour lines), a customer and/or other users may upload an MP3 and/or other file of their favorite sounds. (The sound uploading may be facilitated by wave function component 28 via user interface 18, for example). The sounds may be may be a song, the sound of their son's first wail, a famous speech, and/or other sounds. Based on the scans, the sounds, and/or other information, system 10 (e.g., wave function component 28) may stretch a waveform of the customer's sound file to a length of extrusions necessary to create the shoe. Wave function component 28 may determine the wave functions for the waveforms along the extrusion path of material from additive manufacturing platform 14 to substantially match the amplitude of the user's sound file (e.g., within preset acceptable limits). The resulting g-code file (e.g., the determined wave function) may be used by control component 30 to fabricate the shoe with system 10, and/or sent to a separate 3D printing facility (e.g., physically located near the customer) for fast and efficient manufacturing and delivery. The customer may receive a one-of-a-kind, perfect-fitting shoe with a unique texture representing their favorite sound.

It should be noted that the description herein of the fabrication of a shoe is not intended to be limiting. System 10 (FIG. 1) and/or method 1800 (FIG. 18) may facilitate fabrication of a variety of different additive and/or other (e.g., x, y, z) co-ordinate driven manufacturing objects. System 10 and/or method 1800 may be applicable to any additive manufacturing platforms where local changes in the physical properties of the object being printed are desired. Such platforms may include, but are not limited to, resin based platforms, powder based platforms, laser based platforms, FDM based platforms, and/or other additive manufacturing technologies.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An additive manufacturing system configured to facilitate formation of additive manufacturing objects, the system comprising:
an additive manufacturing platform configured to move in three or more dimensions to process additive manufacturing material to form an object; and
one or more hardware processors configured by machine-readable instructions to:
obtain a virtual three-dimensional representation of the object, the virtual three-dimensional representation conveying one or more physical properties of the object;
determine positions for a layered series of contour lines for the object based on the three-dimensional representation, the layered series of contour lines corresponding to cross-sectional shapes of the object in different two-dimensional layers of the object;
determine individual wave functions based on the contour lines and the one or more physical properties of the object, an individual wave function corresponding to a given contour line for a given layer, an individual wave function indicating a three or more dimensional waveform pathway for the additive manufacturing platform to follow within a given layer when printing the given layer of the object; and
control movement of the additive manufacturing platform and processing of the additive manufacturing material to additively manufacture the object following waveform pathways based on the wave functions determined for the different two-dimensional layers.

2. The system of claim 1, wherein the one or more hardware processors are configured such that the physical properties of the object comprise material properties and physical dimensions of the object, the material properties and physical dimensions specifying one or more shapes, densities, materials, thicknesses, textures, and/or colors of the object.

3. The system of claim 1, wherein the one or more hardware processors are configured such that the wave function comprises one or more of a sine function, a cosine function, a square function, a triangle function, or a saw tooth function.

4. The system of claim 1, wherein the one or more hardware processors are configured such that the wave function comprises a soundwave function, the soundwave function generated based on music, a voice, animal sounds, or sounds from a city.

5. The system of claim 1, wherein the one or more hardware processors are further configured to obtain wave function information and determine the individual wave functions based on the wave function information, the wave function information including one or more of locations of frequency and/or amplitude attractors in the three-dimensional representation, a specification of which portions of which contour lines wave functions should be applied to, a base wave function amplitude, a base wave function frequency, an attractor strength, wave function frequency and/or amplitude thresholds, a filament thickness, or a desired print resolution.

6. The system of claim 1, wherein the one or more hardware processors are configured such that the individual wave functions specify one or more amplitudes, wavelengths, frequencies, and/or periods of individual waveforms followed by the additive manufacturing platform.

7. The system of claim 6, wherein the one or more hardware processors are configured to determine the one or more amplitudes, wavelengths, frequencies, and/or periods of the individual wave functions such that the additively manufactured object has the one or more physical properties of the object conveyed by the three-dimensional representation.

8. The system of claim 6, wherein the one or more hardware processors are configured to determine the one or more amplitudes, wavelengths, frequencies, and/or periods of the individual wave functions such that the additively manufactured object has a knit, weave, and/or fabric-like texture.

9. The system of claim 6, wherein the one or more hardware processors are configured such that controlling movement of the additive manufacturing platform based on the wave functions facilitates additively manufacturing the object without a need for support material for overhanging features.

10. The system of claim 1, wherein the object is a shoe.

11. The system of claim 1, wherein the one or more hardware processors are configured such that controlling movement of the additive manufacturing platform based on the wave functions facilitates additively manufacturing the object with one or more textured and/or smooth surfaces that represent one or more of a style line, a company logo, a biomechanical feature, or a desirable material property.

12. An additive manufacturing method for facilitating formation of additive manufacturing objects, the method comprising:
obtaining a virtual three-dimensional representation of an object, the virtual three-dimensional representation conveying one or more physical properties of the object;
determining positions for a layered series of contour lines for the object based on the three-dimensional representation, the layered series of contour lines corresponding to cross-sectional shapes of the object in different two-dimensional layers of the object;
determining individual wave functions based on the contour lines and the one or more physical properties of the object, an individual wave function corresponding to a given contour line for a given layer, an individual wave function indicating a three or more dimensional waveform pathway for an additive manufacturing platform to follow within a given layer when forming the given layer of the object; and
controlling movement of the additive manufacturing platform and processing of additive manufacturing material to additively manufacture the object following waveform pathways based on the wave functions determined for the different two-dimensional layers.

13. The method of claim 12, wherein the physical properties of the object comprise material properties and physical dimensions of the object, the material properties and physical dimensions specifying one or more shapes, densities, materials, thicknesses, textures, and/or colors of the object.

14. The method of claim 12, wherein the wave function comprises one or more of a sine function, a cosine function, a square function, a triangle function, or a saw tooth function.

15. The method of claim 12, wherein the wave function comprises a soundwave function, the soundwave function generated based on music, a voice, animal sounds, or sounds from a city.

16. The method of claim 12, further comprising obtaining wave function information and determining the individual wave functions based on the wave function information, the wave function information including one or more of locations of frequency and/or amplitude attractors in the three-dimensional representation, a specification of which portions of which contour lines wave functions should be applied to, a base wave function amplitude, a base wave function frequency, an attractor strength, wave function frequency and/or amplitude thresholds, a filament thickness, or a desired print resolution.

17. The method of claim 12, wherein the individual wave functions specify one or more amplitudes, wavelengths, frequencies, and/or periods of individual waveforms followed by the additive manufacturing platform.

18. The method of claim 17, further comprising determining the one or more amplitudes, wavelengths, frequencies, and/or periods of the individual wave functions such that the additively manufactured object has the one or more physical properties of the object conveyed by the three-dimensional representation.

19. The method of claim 17, further comprising determining the one or more amplitudes, wavelengths, frequencies, and/or periods of the individual wave functions such that the additively manufactured object has a knit, weave, and/or fabric-like texture.

20. The method of claim 17, wherein controlling movement of the additive manufacturing platform based on the wave functions facilitates additively manufacturing the object without a need for support material for overhanging features.

21. The method of claim 12, wherein the object is a shoe.

22. The method of claim 12, wherein controlling movement of the additive manufacturing platform based on the wave functions facilitates additively manufacturing the object with one or more textured and/or smooth surfaces that represent one or more of a style line, a company logo, a biomechanical feature, or a desirable material property.
